(19) United States
(12) Patent Application Publication
(10) Pub. No.: US 2014/0006937 A1
(43) Pub. Date: Jan. 2, 2014

(54) CHARACTER FUNCTION USER INTERFACE

(71) Applicant: Roope Aleksi Rainisto, Helsinki (FI)

(72) Inventor: Roope Aleksi Rainisto, Helsinki (FI)

(73) Assignee: NOKIA CORPORATION, Espoo (FI)

(21) Appl. No.: 13/538,569

(22) Filed: Jun. 29, 2012

(51) Int. Cl. G06F 17/00

(52) U.S. Cl. 715/255

(57) ABSTRACT

An apparatus comprising:
at least one processor; and
at least one memory including computer program code,
the at least one memory and the computer program code configured to, with the at least one processor, cause the apparatus to perform at least the following:
enable, in response to one or more characters being highlighted in a display of an electronic device, display of one or more character function user interface elements in place of one or more displayed character entry user interface elements, wherein each character function user interface element is associated with at least one of a formatting function and an editing function which can be performed on the one or more highlighted characters.

### TECHNICAL FIELD

The present disclosure relates to the field of user interfaces, associated methods, computer programs and apparatus. Certain disclosed aspects/embodiments relate to portable electronic devices, for example, so-called hand-portable electronic devices which may be hand-held in use (although they may be placed in a cradle in use). Such hand-portable electronic devices may include so-called Personal Digital Assistants (PDAs), mobile telephones, smartphones and other smart devices, and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

It is common for electronic devices to provide a user interface (e.g. a graphical user interface). A user interface may enable a user to interact with an electronic device, for example, to open applications using application icons, enter commands, to select menu items from a menu, or to enter or edit characters using a virtual keypad. To enter characters, the user may be provided with a physical or virtual keyboard.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus comprising:
at least one processor; and
at least one memory including computer program code,
the at least one memory and the computer program code configured to, with the at least one processor, cause the apparatus to perform at least the following:
in response to one or more characters being highlighted in a display of an electronic device, enable display of one or more character function user interface elements in place of one or more displayed character entry user interface elements, wherein each character function user interface element is associated with at least one of a formatting function and an editing function which can be performed on the one or more highlighted characters.

The character function user interface elements may take the place of the one or more character entry user interface elements by occupying the position within the display previously occupied by the character entry user interface elements. The character function user interface elements may take the place of the one or more character entry user interface elements by at least partially covering/obscuring/overlying the one or more character entry user interface elements. The character function user interface elements may take the place of the one or more character entry user interface elements by at least partially replacing the one or more character entry user interface elements.

Each character entry user interface element may be configured to allow the user to enter one or more corresponding characters into the display of the electronic device. Each character entry user interface element may correspond to one or more characters. For example, a character entry user interface element may correspond to the characters ‘a’, ‘b’ and ‘c’, wherein pressing the character entry user interface element once corresponds to the character ‘a’; twice to the character ‘b’; and thrice to the character ‘c’.

The one or more character entry user interface elements may make up a virtual keyboard or keypad. A keyboard or keypad may comprise an alphanumeric key input area, a numeric key input area, an AZERTY key input area, a QWERTY key input area or an ITU-T E.161 key input area.

A character may form part of a character string. A character string may comprise a series of one or more characters in a particular order.

A character may comprise a combination of one or more of a word, a letter character (e.g. from the Roman, Greek, Arabic or Cyrillic alphabets), a graphic character (e.g. a sinograph, Japanese kana or Korean delineation), a phrase, a syllable, a diacritical mark, an emoticon, and a punctuation mark. A character string may comprise a combination of one or more of: a word; a sentence; a phrase; a free morpheme; a bound morpheme; a root character string; a stem character string; an affix; a prefix and a suffix.

A character string may be recognised by the apparatus/electronic device using one or more delimiters (e.g. spaces, punctuation marks, capital letters, tab character, return character, or another control character), the delimiters being associated with the beginning and/or end of the character string.

The highlighted character string may have been entered by the user of an electronic device (e.g. using the character entry user interface elements). The highlighted character string may not have been entered by the user of the electronic device (e.g. it may have been received from a remote server or via the Internet or other network or from memory).

Highlighting may comprise indicating to the user which characters are highlighted (e.g. by changing the colour of the characters, or providing an indicator). Highlighting a character string may comprise distinguishing the characters of the highlighted character string with respect to other characters (e.g. by making the highlighted characters a different colour to at least one other non-highlighted character). Highlighting may or may not comprise providing one or more of an audio indication (e.g. a beep, or a message announcing the highlighted item), a visual indication and a tactile (e.g. haptic feedback) indication.

The apparatus may be configured to: enable, in response to detecting that a character string is not highlighted or is no longer highlighted, display of one or more character entry user interface elements in place of one or more displayed character function user interface elements, wherein each character entry user interface element is associated with a character which can be entered into an editable text field.

Formatting characters may comprise changing the appearance of the characters. Formatting may comprise, for example, one or more of: changing the colour of one or more highlighted characters; changing the background colour of one or more highlighted characters; changing the font of the one or more highlighted characters (e.g. from ‘Arial’ font to ‘black letter’ font, or from a ‘serif’ font to a ‘sans-serif’ font); changing the size of one or more highlighted characters; changing the case of one or more highlighted characters (e.g. from all capitals to sentence case); underlining one or more highlighted characters; emboldening one or more highlighted characters; and italicising one or more highlighted characters.

Editing may be considered to encompass changing which characters are displayed (e.g. by deleting or replacing characters). For example, editing may comprise one or more of: deleting one or more highlighted characters, copying one or more highlighted characters; replacing one or more highlighted characters with other characters (e.g. providing a corrected spelling, or providing a synonym); pasting one or more characters; and cutting one or more highlighted characters.

The user interface elements may be provided by a user interface. The user interface may comprise a combination of one or more of a touchpad, and a touch-screen. The user interface may comprise a display configured to display a cursor to allow the user to interact with the displayed user interface elements (e.g. the cursor may be controlled by a mouse or wand).

A user interface element may comprise a key, an icon, a shortcut, or a menu item

The electronic device or the apparatus may be a portable electronic device, a laptop computer, a desktop computer, a mobile phone, a Smartphone, a monitor, a personal digital assistant or a digital camera, or a module for the same.

In a further aspect, there is provided a method, the method comprising:
enabling, in response to one or more characters being highlighted in a display of an electronic device, display of one or more character function user interface elements in place of one or more displayed character entry user interface elements, wherein each character function user interface element is associated with at least one of a formatting function and an editing function which can be performed on the one or more highlighted characters.

In a further aspect, there is provided a computer program, the computer program comprising code configured to:
in response to one or more characters being highlighted in a display of an electronic device, enable display of one or more character function user interface elements in place of one or more displayed character entry user interface elements, wherein each character function user interface element is associated with at least one of a formatting function and an editing function which can be performed on the one or more highlighted characters.

The computer program may be stored on a storage media (e.g. on a CD, a DVD, a memory stick or other non-transitory medium). The computer program may be configured to run on a device or apparatus as an application. An application may be run by a device or apparatus via an operating system. The computer program may form part of a computer program product.

In a further aspect, there is provided an apparatus, the apparatus comprising:
means for enabling display, in response to one or more characters being highlighted in a display of an electronic device, one or more character function user interface elements in place of one or more displayed character entry user interface elements, wherein each character function user interface element is associated with at least one of a formatting function and an editing function which can be performed on the one or more highlighted characters.

In a further aspect, there is provided an apparatus, the apparatus comprising:
an enabler configured to enable, in response to one or more characters being highlighted in a display of an electronic device, display of one or more character function user interface elements in place of one or more displayed character entry user interface elements, wherein each character function user interface element is associated with at least one of a formatting function and an editing function which can be performed on the one or more highlighted characters.

The present disclosure includes one or more corresponding aspects, embodiments or features in isolation or in various combinations whether or not specifically stated (including claimed) in that combination or in isolation. Corresponding means and corresponding function units (e.g. first enabler, second enabler) for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 depicts an example embodiment comprising a number of electronic components, including memory and a processor.

FIG. 2 depicts an example embodiment comprising a number of electronic components, including memory, a processor and a communication unit.

FIG. 3 depicts an example embodiment comprising a number of electronic components, including memory, a processor and a communication unit.

FIG. 4a-4d depicts an example embodiment wherein the one or more character function user interface elements replace one or more character entry user interface elements.

FIG. 5a-5e depicts a further example embodiment wherein the one or more character function user interface elements overlie one or more character entry user interface elements.

FIGS. 6a-6b illustrate an example apparatus in communication with a remote server/cloud.

FIG. 7 illustrates a flowchart according to an example method of the present disclosure.

FIG. 8 illustrates schematically a computer readable medium providing a program.

### DESCRIPTION OF EXAMPLE ASPECTS/EMBODIMENTS

It is common for a user to employ an electronic device to enter characters via a user interface, for example, to write a text message, enter a search term, or write a letter. In order to enter characters, conventional user interfaces have utilised keys which correspond to one or more characters. When the user presses a key, a corresponding character is entered.

Other character input user interfaces are configured to allow the user to interact with character which are already available. For example text editing software may allow a user to format text to control its appearance. However, additional functionality (e.g. to allow text formatting) may be difficult to provide on a size-limited (e.g. portable) display. It may be advantageous to provide character entry user interface elements when the user wants to enter characters, and character function user interface elements in place of the character entry user interface elements when the user wishes to edit or format characters.

At least some example embodiments contained herein may be considered to provide a way of providing one or more character function user interface elements in the place of one or more character entry user interface elements, when one or more characters are highlighted. It will be appreciated that, as the character function user interface occupy the same position as the character entry user interface elements, the space available to display other information (such as the characters themselves or other information or other user interface elements) may be increased/not diminished. Providing editing and formatting functionality when characters are highlighted, and character entry capability when characters are not highlighted, may provide a more intuitive user interface.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

FIG. 1 shows an apparatus (101) comprising memory (107), a processor (108), input I and output O. In this embodiment only one processor and one memory are shown but it will be appreciated that other embodiments may utilise more than one processor and/or more than one memory (e.g. same or different processor/memory types).

In this embodiment the apparatus (101) is an Application Specific Integrated Circuit (ASIC) for a portable electronic device with a touch sensitive display. In other embodiments the apparatus (101) can be a module for such a device, or may be the device itself, wherein the processor (108) is a general purpose CPU of the device and the memory (107) is general purpose memory comprised by the device.

The input I allows for receipt of signalling to the apparatus 101 from further components, such as components of a portable electronic device (like a touch-sensitive display) or the like. The output O allows for onward provision of signalling from within the apparatus 101 to further components. In this embodiment the input I and output O are part of a connection bus that allows for connection of the apparatus 101 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 108, 107. In this example the components are all located proximate to one another so as to be formed together as an ASIC, in other words, so as to be integrated together as a single chip/circuit that can be installed into an electronic device. In other examples one or more or all of the components may be located separately from one another.

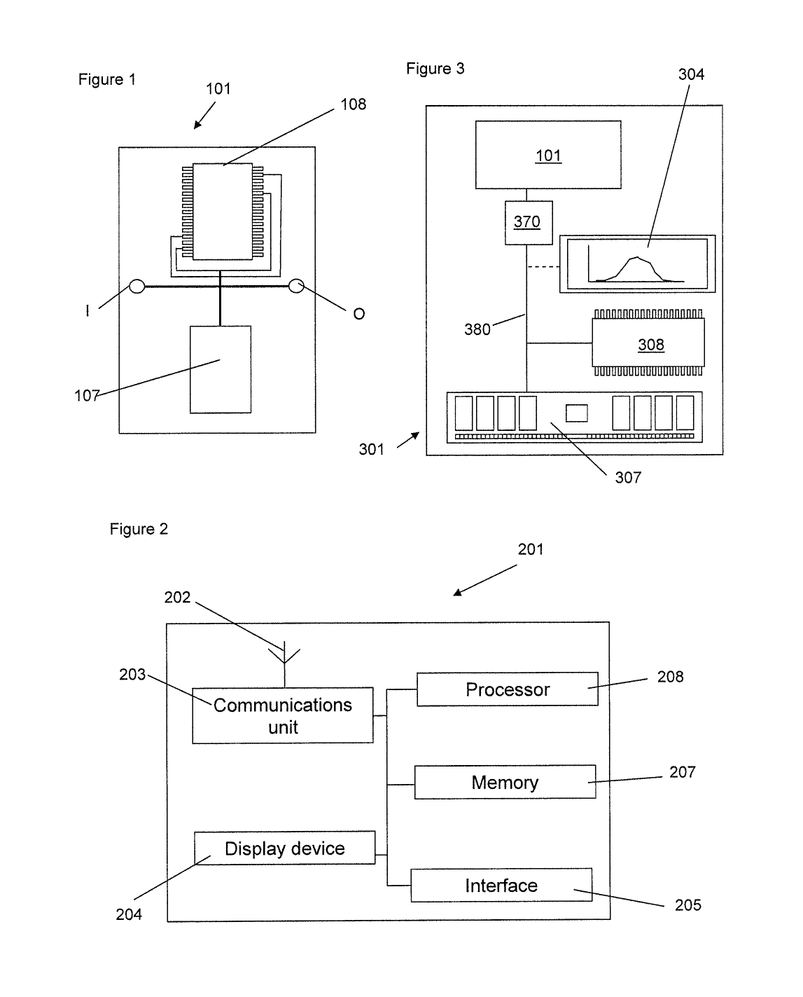

FIG. 2 depicts an apparatus (201) of a further example embodiment, such as a mobile phone. In other example embodiments, the apparatus (201) may comprise a module for a mobile phone (or PDA or audio/video player), and may just comprise a suitably configured memory (207) and processor (208).

The example embodiment of FIG. 2, in this case, comprises a display device (204) such as, for example, a Liquid Crystal Display (LCD) or touch-screen user interface. The apparatus (201) of FIG. 2 is configured such that it may receive, include, and/or otherwise access data. For example, this example embodiment (201) comprises a communications unit (203), such as a receiver, transmitter, and/or transceiver, in communication with an antenna (202) for connecting to a wireless network and/or a port (not shown) for accepting a physical connection to a network, such that data may be received via one or more types of networks. This example embodiment comprises a memory (207) that stores data, possibly after being received via antenna (202) or port or after being generated at the user interface (205). The processor (208) may receive data from the user interface (205), from the memory (207), or from the communication unit (203). It will be appreciated that, in certain example embodiments, the display device (204) may incorporate the user interface (205). Regardless of the origin of the data, these data may be outputted to a user of apparatus (201) via the display device (204), and/or any other output devices provided with apparatus. The processor (208) may also store the data for later use in the memory (207). The memory (207) may store computer program code and/or applications which may be used to instruct/enable the processor (208) to perform functions (e.g. read, write, delete, edit or process data).

FIG. 3 depicts a further example embodiment of an electronic device (301), such as a tablet personal computer, a portable electronic device, a portable telecommunications device, a server or a module for such a device, the device comprising the apparatus (101) of FIG. 1. The apparatus (101) can be provided as a module for device (301), or even as a processor/memory for the device (301) or a processor/memory for a module for such a device (301). The device (301) comprises a processor (308) and a storage medium (307), which are connected (e.g. electrically and/or wirelessly) by a data bus (380). This data bus (380) can provide an active coupling between the processor (308) and the storage medium (307) to allow the processor (308) to access the computer program code. It will be appreciated that the components (e.g. memory, processor) of the device/apparatus may be linked via cloud computing architecture. For example, the storage device may be a remote server accessed via the internet by the processor.

The apparatus (101) in FIG. 3 is connected (e.g. electrically and/or wirelessly) to an input/output interface (370) that receives the output from the apparatus (101) and transmits this to the device (301) via data bus (380). Interface (370) can be connected via the data bus (380) to a display (304) (touch-sensitive or otherwise) that provides information from the apparatus (101) to a user. Display (304) can be part of the device (301) or can be separate. The device (301) also comprises a processor (308) configured for general control of the apparatus (101) as well as the device (301) by providing signalling to, and receiving signalling from, other device components to manage their operation.

The storage medium (307) is configured to store computer code configured to perform, control or enable the operation of the apparatus (101). The storage medium (307) may be configured to store settings for the other device components. The processor (308) may access the storage medium (307) to retrieve the component settings in order to manage the operation of the other device components. The storage medium (307) may be a temporary storage medium such as a volatile random access memory. The storage medium (307) may also be a permanent storage medium such as a hard disk drive, a flash memory, a remote server (such as cloud storage) or a non-volatile random access memory. The storage medium (307) could be composed of different combinations of the same or different memory types.

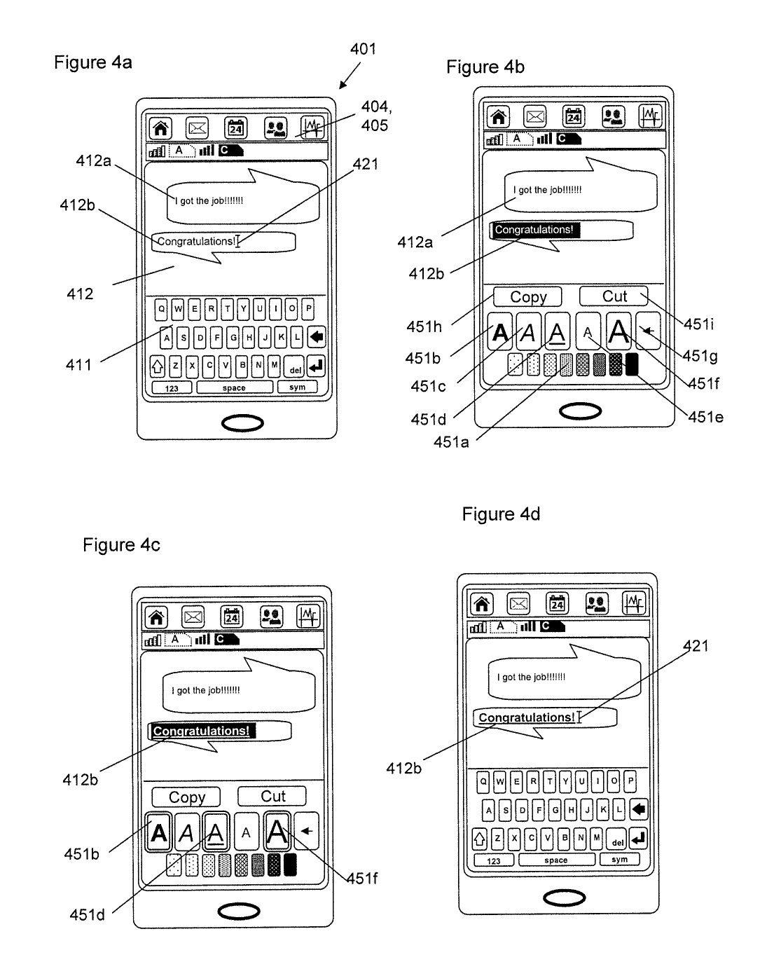

FIGS. 4a-4d depicts an example embodiment of the apparatus depicted in FIG. 2 comprising a portable electronic communications device (401), e.g. such as a mobile phone, with a user interface comprising a touch-screen user interface (405, 404), a memory (not shown), a processor (not shown) and an antenna (not shown) for transmitting and/or receiving data (e.g. emails, textual messages, phone calls, information corresponding to web pages).

In the situation depicted in FIG. 4a, the device is displaying a messaging application. When in the messaging application is running, the screen is configured to show a message region (412) and a character entry region (411). In this case, the message region is configured to display a messaging conversation comprising a received message (412a) and an editable message (412b) which is in the process of being composed/edited. The character entry region (411) comprises character entry user interface elements forming a QWERTY keyboard which the user is using to enter characters into the editable message. That is, in this case, the character entry user interface elements are keys of a virtual keyboard. It will be appreciated that in other example embodiments, the character entry user interface elements may be, for example, icons or menu items.

When the user is entering characters, a character cursor (421) is displayed in the editable message (412b) indicating the position characters would be entered. To enter a character, the user selects a character entry user interface element key from the virtual keyboard (411) and the corresponding character will be entered into the editable message (412b) at the position of the character cursor (421). By pressing a sequence of keys of the virtual keyboard, the desired character string can be entered. It will be appreciated that the apparatus/device may support predictive text entry (e.g. where the apparatus/device proposes candidate words based on the entered portion of the character string), and/or disambiguation text entry (e.g. where the apparatus/device proposes candidate words based on an ambiguous entered text string).

In this case, the user has entered the text string ‘Congratulations!’ by pressing the corresponding sequence of character entry user interface element keys of the keyboard (411). In this example, the user wishes to format the appearance of the text. To change the appearance of the text, the user first highlights a portion of text using a dragging gesture (or a double-tap). In this case, the complete character string of the editable message is highlighted, as shown in FIG. 4b. It will be appreciated that other example embodiments can be configured to enable a partial text string to be highlighted. The text is denoted as being highlighted by the background changing colour to black, and the text changing colour to white.

It will be appreciated that, in other example embodiments, the text may be denoted as being highlighted by providing one or more of an audio indication (e.g. a beep, or a message announcing the highlighted item), a visual indication (e.g. as discussed above) and a tactile (e.g. haptic feedback) indication.

In this embodiment, the apparatus is configured to enable display, in response to one or more characters being highlighted in a display of an electronic device, one or more character function user interface elements (451) in place of one or more displayed character entry user interface elements (411), wherein each character function user interface element (451a-i) is associated with at least one of a formatting function and an editing function which can be performed on the one or more highlighted characters. That is, the one or more character function user interface elements are configured to occupy at least partially the same position of the screen as the at least one character entry user interface elements did. In this case, the one or more character function user interface elements (451a-i) are configured to replace the virtual keyboard (411) comprising the character entry user interface elements. This is shown in FIG. 4b. It will be appreciated that in other embodiments, only a portion, or even more than the entire visual keyboard (411) could be occupied by the character function user interface elements.

In this case, the character function user interface elements comprise a number of colour formatting user interface elements (451a), configured to allow the user to select the colour of the highlighted text; font style user interface elements (451b-d), configured to allow the user to select the font style of the selected text (e.g. whether it is italicised, emboldened and/or underlined); font size user interface elements (451e-f) configured to allow the user to enlarge or reduce the font size; a delete user interface element (451g) configured to allow the user to delete the highlighted text; a copy user interface element (451h) configured to allow the user to copy the text to a clipboard; and a cut user interface element (451i) configured to allow the user to copy the text to a clipboard and delete the highlighted text.

It will be appreciated that other example embodiments may be configured to provide other character functions. For example, other example embodiments may be configured to enable a spell-check function configured to allow the user to correct misspelt words; or to enable a synonym function configured to allow the user to replace a highlighted word with a synonym.

In this case, the user wishes to convey his excitement at his friend's news and so wishes to enlarge the font size of the text, underline and embolden the highlighted text. To do this, the user selects the user interface elements corresponding with these functions (as shown in FIG. 4c). That is, the user selects the enlarge font size user interface element (451f), the embolden font style user interface element (451b), and the underline font style user interface element (451d). In this embodiment, the text is configured to remain highlighted whilst the user is interacting with the character formatting user interface elements. Once the user has completed formatting the highlighted text, the user selects a position within the entered text string (at this case at the end of the entered text string). By selecting a position within the text string, the apparatus is configured to remove the un-highlight the previously highlighted character string and position the character entry cursor (421) at the selected position. This is shown in FIG. 4d. This unhighlighting can, of course, be done automatically after the selection of a particular formatting/editing function, or by the provision of a specific formatting/editing complete user interface element of even by accepting a particular gesture on the user interface.

In response to detecting that no character string is highlighted, the apparatus is configured to: enable, in response to detecting that a character string is not highlighted or is no longer highlighted, display of one or more character entry user interface elements in place of one or more displayed character function user interface elements, wherein each character entry user interface element is associated with a character which can be entered into an editable text field. That is, the one or more character entry user interface elements are configured to occupy the same position of the screen as the at least one character function user interface elements did. It will be appreciated that, for other example embodiments, the apparatus/device may be configured to display the character entry user interface elements in response to a character entry cursor being present in an editable text field.

After the user has completed editing and formatting the text, he may transmit it to his friend.

It will be appreciated that, by positioning the character function user interface elements in the place of the character entry user interface elements, the space available for showing other information (e.g. web-pages, graphics) is increased or at least not necessarily diminished. This may allow devices to be made smaller, or more information to be displayed. In addition, as the functionality of the displayed user interface elements is linked to how the user is interacting with text, the user may be provided with a more intuitive user interface.

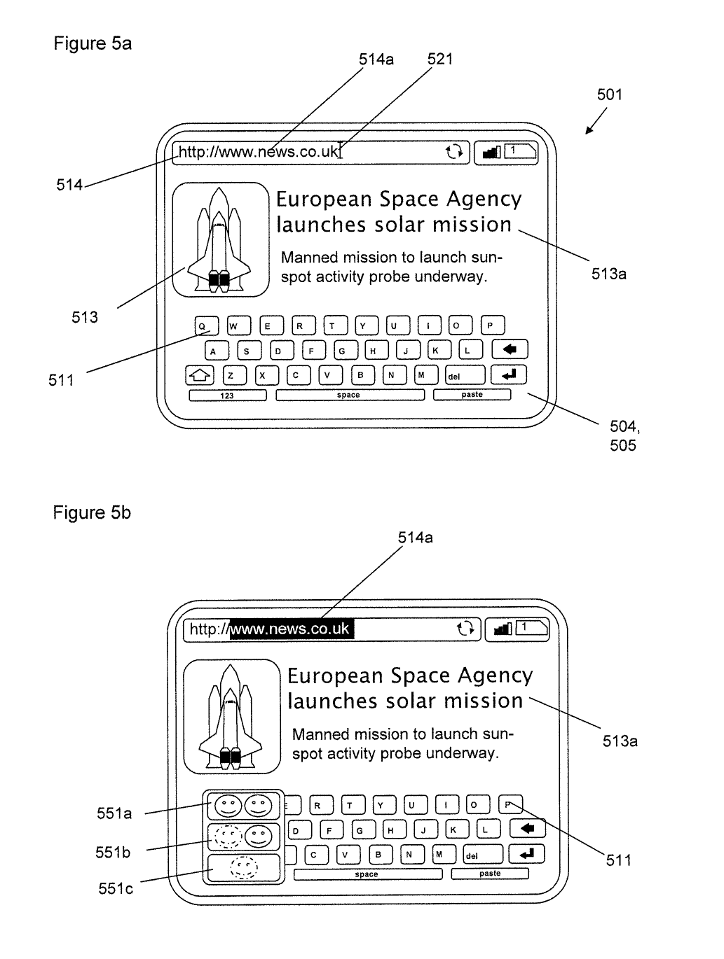

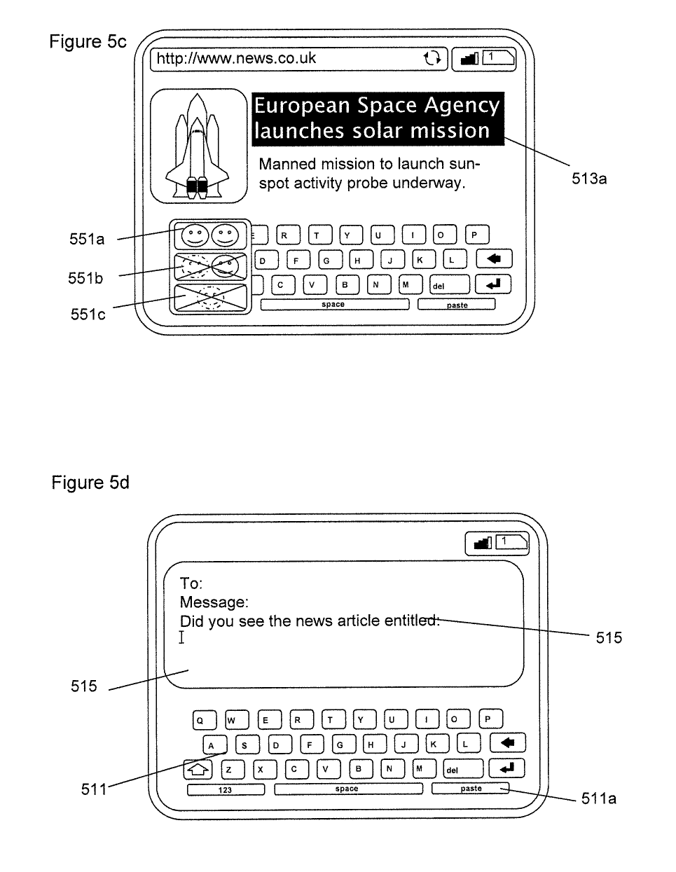

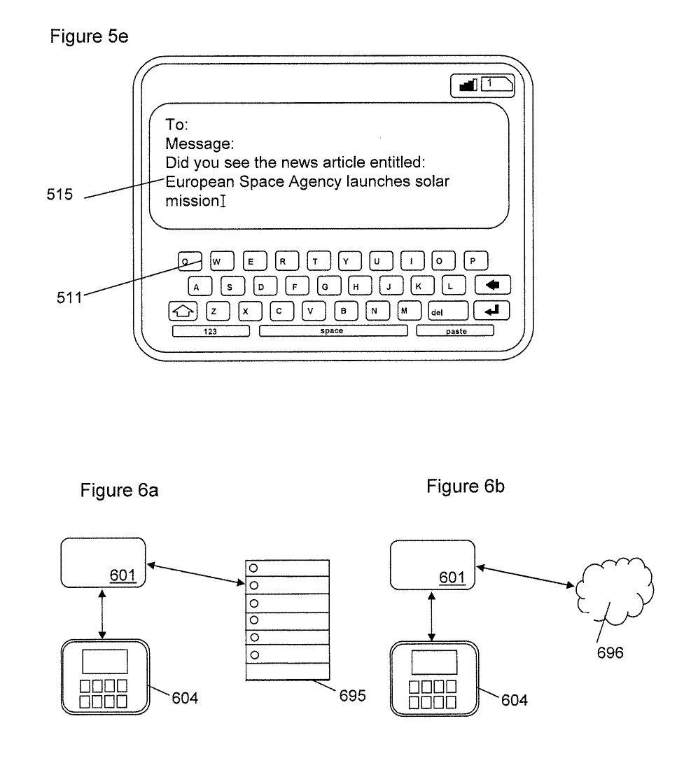

FIGS. 5a-5e depicts a further example embodiment comprising a portable electronic communications device (501), e.g. such as a tablet computer, with a user interface comprising a touch-screen user interface (505, 504), a memory (not shown), a processor (not shown) and an antenna (not shown) for transmitting and/or receiving data (e.g. emails, textual messages, phone calls, information corresponding to web pages).

In the situation depicted in FIG. 4a, the device is displaying a web browser application. When in the web browser application, the screen is configured to show an address bar (514) (in this case a URL text entry field); a web page region (513); and a character entry region (511). In this case, the address bar (514) is configured to allow the user to enter text corresponding to a URL (e.g. a website address). In the situation depicted in FIG. 5a, the web page (513) comprises read-only text (513a). It will be appreciated that other web pages may comprise editable text fields (e.g. online forms, comment fields, social networking websites). In FIG. 5a, the character entry region (411) comprises character entry user interface elements making up a QWERTY keyboard which the user is using to enter characters into the editable message.

In order to enter characters, a character cursor (521) is displayed in the editable address bar (514) indicating the position characters would be entered. To enter a character, the user selects a character entry user interface element key from the virtual keyboard (511) and the corresponding character will be entered into the editable address bar at the position of the character cursor. By pressing a sequence of keys of the virtual keyboard, the desired character string (514a) can be entered. It will be appreciated that the apparatus/device may support predictive text entry (e.g. where the apparatus/device proposes candidate words based on the entered portion of the character string), or disambiguation text entry (e.g. where the apparatus/device proposes candidate words based on an ambiguous entered text string).

In this case, the user has entered the text string ‘www.news.co.uk’ (514a) into the address bar (514) by pressing the corresponding sequence of character entry user interface elements of the keyboard (511). In this example, the user initially wishes to copy a portion of the entered character string (514a) from the editable address field. To copy the one or more characters of the desired portion of text, the user first highlights a portion of the character string using a dragging gesture. As shown in FIG. 5b, the one or more characters are denoted as being highlighted by the background changing colour to black, and the text changing colour to white.

In this embodiment, the apparatus is configured to enable, in response to one or more characters being highlighted in a display of an electronic device, display of one or more character function user interface elements (551a-551b) in place of one or more displayed character entry user interface elements (511), wherein each character function user interface element (551a-551b) is associated with at least one of a formatting function and an editing function which can be performed on the one or more highlighted characters. That is, the one or more character function user interface elements are configured to occupy at least partially the same position of the screen as at least one character entry user interface element did. In this case, rather than replacing the character entry keyboard as in the previous embodiment, the character function user interface elements are displayed to appear to the viewer that they occupy a plane above the character entry virtual keyboard. This is shown in FIG. 5b. That is, the character function user interface elements are configured to cover/obscure at least partially one or more character entry user interface elements of the virtual keyboard (511).

In this case, the character function user interface elements comprise a copy user interface element (551a) configured to allow the user to copy the text to a clipboard; a cut (551b) user interface element configured to allow the user to copy the text to a clipboard and delete the highlighted text; and a delete user interface element (551c) configured to allow the user to delete the highlighted text. Copying, cutting and deleting characters may be considered to be editing functions. The delete character function user interface element may be configured to allow the user to delete the highlighted text and position a text entry cursor at the last character before the deleted text. As the text would no longer be highlighted, the apparatus/device may be configured to display one or more character entry user interface elements in the place of the one or more character function user interface elements automatically after deletion.

It will be appreciated that other example embodiments may be configured to provide other character function user interface elements. For example, other example embodiments may be configured to enable a spell-check function configured to allow the user to correct misspelt words; or to enable a synonym function configured to allow the user to replace a highlighted word with a synonym. Other example embodiments configured to disambiguate ambiguous key sequences may be configured to allow a user to highlight an entered unambiguous character string and change the highlighted character string to a different unambiguous character string associated with the same ambiguous key sequence. For example, if the character entry user interface elements made up an ITU-T E.161 keyboard, the user may select the ambiguous key sequence ‘7’, ‘4’, ‘6’, ‘8’. The processor may disambiguate this key sequence to enter the word character string ‘pint’ by default. However, the user may wish to enter the word ‘riot’ (which also corresponds to the entered ambiguous key sequence). An embodiment may be configured to allow the user to highlight the entered character string ‘pint’, and in response to the characters being highlighted display character function user interface elements corresponding to alternative (e.g. suggested) unambiguous character strings (in this case including the word ‘riot’).

In this case, the user then decides to copy the headline text of the news article (513a) rather than the URL. The user then selects the characters making up the news headline from the web page (513). This is shown in FIG. 5c. In the same way as when the characters of the address bar are highlighted, the apparatus is configured to enable, in response to one or more characters of the web page being highlighted in a display of an electronic device, display of one or more character function user interface elements in place of one or more displayed character entry user interface elements, wherein each character function user interface element is associated with at least one of a formatting function and an editing function which can be performed on the one or more highlighted characters. That is, the one or more character function user interface elements are configured to occupy at least partially the same position of the screen as the at least one character entry user interface elements did.

In this example embodiment, the character function user interface elements available are dependent on the type of characters highlighted (although in certain embodiments, the character function user interface elements may be independent of the characters highlighted). For example, if the characters are editable, such as those in the editable address bar, user interface elements corresponding to the delete function and to the cut function are made available. However, if the highlighted text is read-only, such as the text of the web page, the delete and cut function user interface elements are displayed as being unavailable (denoted by having a diagonal cross).

To copy the highlighted text, the user selects the copy user interface element (551a) corresponding with the copy function. Once the user has completed editing the highlighted text by copying the highlighted text the user navigates to a separate email application. This is shown in FIG. 5d.

When in the email application, the user enters text into the message entry field using a text entry cursor. In response to detecting that no character string is highlighted, the apparatus is configured to enable, in response to one or more characters being un-highlighted in a display of an electronic device, display of one or more character entry user interface elements in place of one or more displayed character function user interface elements, wherein each character entry user interface element is associated with a character which can be entered into an editable text field. That is, the one or more character entry user interface elements are configured to occupy at least partially the same position of the screen as the at least one character function user interface elements did. It will be appreciated that, for other example embodiments, the apparatus/device may be configured to display the character entry user interface elements in response to a character entry cursor being present in an editable text field.

In this case, the messaging application comprises an editable message field (515), in which the user can enter characters to form a textual message for transmission.

After the user has entered a character string (515a) into the message field (515) by pressing the appropriate sequence of character entry user interface elements of the virtual keyboard (511) (as shown in FIG. 5d), the user wishes to enter/paste the copied text at the position of the text entry cursor. In this example, the virtual keyboard (511) comprises a paste key (511a) configured to allow the user to enter characters stored in the clipboard at the position of the text entry cursor. After the user has activated the paste character entry user interface element, the copied character string stored in the clipboard is inserted into the editable message field (515). This is shown in FIG. 5e. It will be appreciated that other example embodiments may be configured to provide a paste user interface element as a character function user interface element and/or as a character entry user interface element.

It will be appreciated that other example embodiments may be configured to provide other character function user interface elements. For example, other character function user interface elements may be associated with formatting the highlighted text (e.g. changing the font size, font colour or font type).

Although the above embodiments each had a touch screen user interface, it will be appreciated other example embodiments may not have a touch screen. For example, the character entry and character function user interface elements may be selected using a cursor controlled by a mouse or touch pad.

FIG. 6a shows that an example embodiment of an apparatus in communication with a remote server. FIG. 6b shows that an example embodiment of an apparatus in communication with a “cloud” for cloud computing. In FIGS. 6a and 6b, apparatus (601) (which may be apparatus (101), (201) or (301)) is in communication with a display (604). Of course, the apparatus (601) and display (604) may form part of the same apparatus/device, although they may be separate as shown in the figures. The apparatus (601) is also in communication with a remote computing element. Such communication may be via a communications unit, for example. FIG. 6a shows the remote computing element to be a remote server (695), with which the apparatus may be in wired or wireless communication (e.g. via the internet, Bluetooth, a USB connection, or any other suitable connection as known to one skilled in the art). In FIG. 6b, the apparatus (601) is in communication with a remote cloud (696) (which may, for example, by the Internet, or a system of remote computers configured for cloud computing). It may be that the characters and/or at least some user applications are stored/run at the remote computing element (695), (696) and accessed by the apparatus (601) for display (604). The user applications need not all be stored at the same location. Some or all of the user applications and/or user content may be stored at the apparatus (101), (201), (301). The provision of a user interface elements may be at the respective remote computing element (695), (696). The apparatus (601) may actually form part of the remote sever (695) or remote cloud (696). In such embodiments, the enablement of the character entry and character function user interface elements may be conducted by the server or in conjunction with use of the server/cloud.

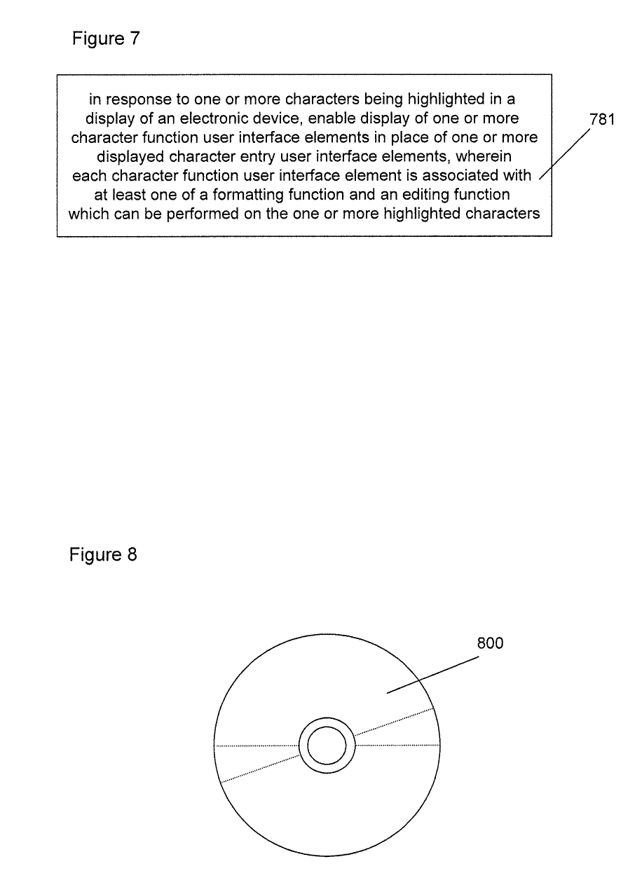

FIG. 7 illustrates the process flow according to an example embodiment of the present disclosure. The process comprises enabling (781) in response to one or more characters being highlighted in a display of an electronic device, display of one or more character function user interface elements in place of one or more displayed character entry user interface elements, wherein each character function user interface element is associated with at least one of a formatting function and an editing function which can be performed on the one or more highlighted characters.

FIG. 8 illustrates schematically a computer/processor readable medium (800) providing a program according to an embodiment. In this example, the computer/processor readable medium is a disc such as a Digital Versatile Disc (DVD) or a Compact Disc (CD). In other embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features of the disclosure as applied to examples thereof, it will be understood that various omissions and substitutions and changes in the form and details of the devices and methods described may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
in response to one or more characters being highlighted in a display of an electronic device, enable display of one or more character function user interface elements in place of one or more displayed character entry user interface elements, wherein each character function user interface element is associated with at least one of a formatting function and an editing function which can be performed on the one or more highlighted characters.

2. The apparatus of claim 1, wherein the each character entry user interface element is configured to allow the user to enter a corresponding character into the display of the electronic device.

3. The apparatus of claim 1, wherein the character function user interface elements replace the one or more character entry user interface elements by at least partially covering the one or more character entry user interface elements.

4. The apparatus of claim 1, wherein the one or more character entry user interface elements make up a virtual keyboard.

5. The apparatus of claim 1, wherein the formatting function comprises one or more of:
changing the colour of one or more highlighted characters;
changing the background colour of one or more highlighted characters;
changing the font style of the one or more highlighted characters;
changing the font of the one or more highlighted characters;
changing the size of one or more highlighted characters;
changing the case of one or more highlighted characters;
underlining one or more highlighted characters;
emboldening one or more highlighted characters; and
italicising one or more highlighted characters.

6. The apparatus of claim 1, wherein the editing function comprises one or more of:
deleting one or more highlighted characters,
copying one or more highlighted characters;
replacing one or more highlighted characters with other suggested characters;
pasting one or more characters; and
cutting one or more highlighted characters.

7. The apparatus of claim 1, wherein a character comprises a combination of one or more of a word, a letter character, a graphic character, a sinograph, a Japanese kana, or Korean Hangul, a phrase, a syllable, a diacritical mark, an emoticon, and a punctuation mark.

8. The apparatus of claim 1, wherein a character forms part of a character string.

9. The apparatus of claim 1, wherein a character is indicated as being highlighted by providing one or more of an audio indication, a visual indication and a tactile indication.

10. The apparatus of claim 1, wherein the apparatus is configured to:
enable, in response to detecting that a character string is not highlighted or is no longer highlighted, display of one or more character entry user interface elements in place of one or more displayed character function user interface elements, wherein each character entry user interface element is associated with a character which can be entered into an editable text field.

11. The apparatus of claim 1, wherein a user interface element comprises a key, an icon, a shortcut, or a menu item.

12. The apparatus of claim 1, wherein the one or more character function user interface elements available are dependent on the type of characters highlighted.

13. The apparatus of claim 1, wherein the user interface comprises a combination of one or more of a touchpad, and a touch-screen.

14. The apparatus of claim 1, wherein the electronic device or the apparatus is a mobile phone, a Smartphone, or a module for the same.

15. The apparatus of claim 1, wherein the electronic device or the apparatus is a portable electronic device, a laptop computer, a desktop computer, a monitor, a personal digital assistant or a digital camera, or a module for the same.

16. A method, the method comprising:
enabling, in response to one or more characters being highlighted in a display of an electronic device, display of one or more character function user interface elements in place of one or more displayed character entry user interface elements, wherein each character function user interface element is associated with at least one of a formatting function and an editing function which can be performed on the one or more highlighted characters.

17. A computer program, the computer program comprising code configured to:
enable in response to one or more characters being highlighted in a display of an electronic device, display of one or more character function user interface elements in place of one or more displayed character entry user interface elements, wherein each character function user interface element is associated with at least one of a formatting function and an editing function which can be performed on the one or more highlighted characters.
